(19) United States
(12) Patent Application Publication
(10) Pub. No.: US 2008/0238857 A1
(43) Pub. Date: Oct. 2, 2008

(54) DISPLAY DEVICE AND METHOD FOR CONTROLLING BACKLIGHT MODULE OF THE DISPLAY DEVICE

(75) Inventors: LING ZHANG, Shenzhen (CN); WEN-HAW TSENG, Tu-Cheng (TW); SHIH-FANG WONG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/859,794

(22) Filed: Sep. 24, 2007

(30) Foreign Application Priority Data
Mar. 30, 2007 (CN) 200710200368.2

(51) Int. Cl. G09G 3/36

(52) U.S. Cl. 345/102

(57) ABSTRACT

A method for controlling a backlight module of a display device includes: generating an acceleration signal representing the magnitude of an acceleration of the display device; comparing the acceleration signal with a predetermined threshold to determine whether the acceleration signal is greater than the predetermined threshold; and changing a state of the backlight module if the acceleration signal is greater than the predetermined threshold.

### BACKGROUND OF THE INVENTION

1. Field of the Invention

The present invention generally relates to display devices and, more particularly, to a system and method for controlling a backlight module of a display device.

2. Description of Related Art

Display devices are wildly used in computer monitors, portable DVD players, and other electronic apparatuses to display text, image, and video information.

Referring to FIG. 4, a schematic diagram of a LCD display device 400 is illustrated. The LCD display device 400 includes a power supply 402, a power management unit 404, a backlight module 406, and a signal processor 408 for processing signals. The LCD display device 400 further includes an LCD panel 410, a gate driver 412, and a data driver 414 for driving the LCD panel 410 to display the signals. The power management unit 404 is coupled to the power supply 402 for managing and supplying the power to components of the LCD display device 400, such as the backlight module 406 and the signal processor 408. The backlight module 406 is arranged for illuminating the LCD panel 410. Each pixel of the LCD panel 410 includes a layer of liquid crystal material aligned between two transparent electrodes. Surfaces of the electrodes in contact with the liquid crystal material are treated so as to align the liquid crystal material in a particular direction. Before applying an electric field, the orientation of the liquid crystal material is determined by the alignment at the surfaces. In a twisted nematic device (the most common liquid crystal device), the surfaces of the two electrodes are perpendicular to each other, and so LCD molecules of the liquid crystal material arrange themselves in a helical manner, or in a twist.

When a voltage is applied across the electrodes, a torque acts to align the liquid crystal molecules parallel to the electric field, distorting the helical structure. If the applied voltage is large enough, the liquid crystal molecules are completely untwisted and the polarization of the incident light from the backlight module 406 is not rotated at all as it passes through the liquid crystal layer. By controlling the voltage applied across the liquid crystal molecules in each pixel, light emitted by the backlight module 406 can be allowed to pass through in varying amounts, correspondingly illuminating the pixel.

Traditionally, the backlight module 406 of the LCD display device 400 is powered on or powered off manually by pressing a power switch of the LCD display device 400. However, it is inconvenient to pressing the power switch if the user is behind the LCD display device 400.

Therefore, an improved system and method for controlling the backlight module is desired.

### SUMMARY OF THE INVENTION

A display device includes a backlight module, a power management unit, a sensor for detecting an acceleration of the display device and generating an acceleration signal representing a magnitude of the acceleration, and a signal processor. The signal processor is used for determining whether the acceleration signal is greater than a predetermined threshold and controlling the power management unit to change a state of the backlight module if the acceleration signal is greater than the predetermined threshold.

A method for controlling a backlight module of a display device includes: generating an acceleration signal representing the magnitude of an acceleration of the display device; comparing the acceleration signal with a predetermined threshold to determine whether the acceleration signal is greater than the predetermined threshold; and changing a state of the backlight module if the acceleration signal is greater than the predetermined threshold.

Other advantages and novel features will become more apparent from the following detailed description of preferred embodiments when taken in conjunction with the accompanying drawings.

### BRIEF DESCRIPTION OF THE DRAWINGS

Many aspects of the system and method for controlling the backlight module can be better understood with reference to the following drawings. The components in the drawings are not necessarily to scale, the emphasis instead being placed upon clearly illustrating the principles of the present system. Moreover, in the drawings, like reference numerals designate corresponding parts throughout the several views.

FIG. 1 is a block diagram of a display device in accordance with an exemplary embodiment;

FIG. 2 is a flow chart illustrating a procedure of a first method for controlling backlight module of the display device of FIG. 1;

FIG. 3 is a flow chart illustrating a procedure of a second method for controlling backlight module of the display device of FIG. 1; and

FIG. 4 is a block diagram of a traditional display device.

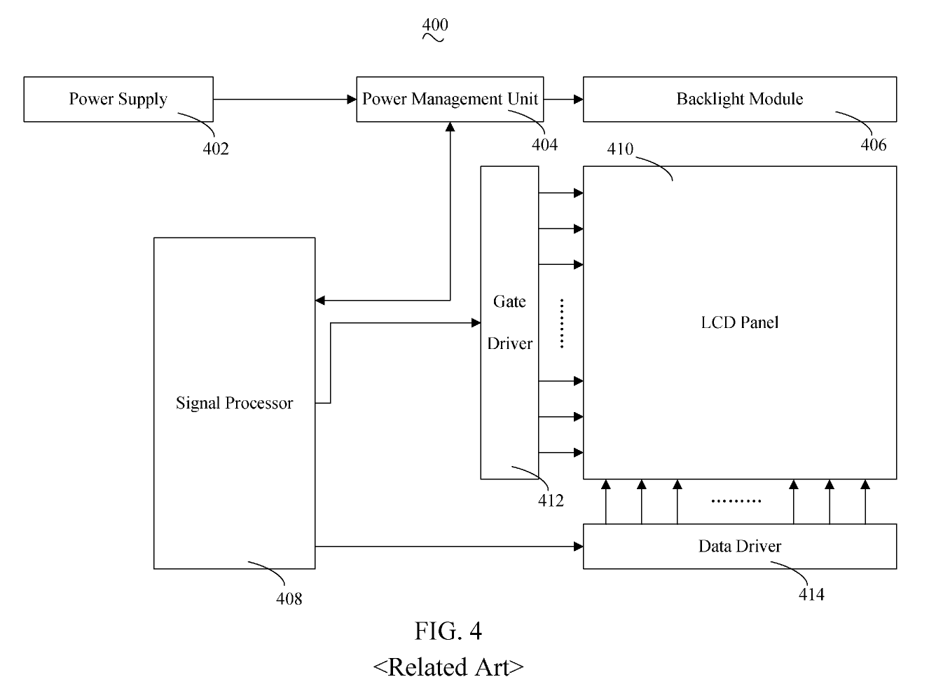

### DETAILED DESCRIPTION OF THE INVENTION

Reference will now be made to the drawings to describe, in detail, a preferred embodiment of the present system and method for controlling a backlight module of a display device.

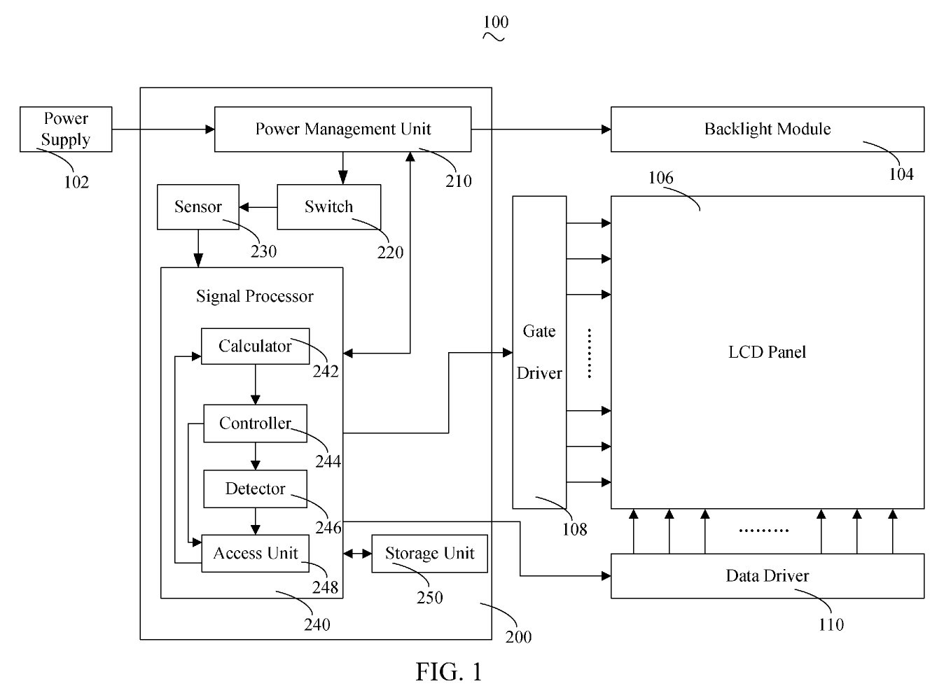

Referring to FIG. 1, a block diagram of a display device 100 in accordance with an exemplary embodiment is illustrated. The display device 100 includes a power supply 102, a control system 200, a backlight module 104, an LCD panel 106, a gate driver 108, and a data driver 110.

The power supply 102 is used for supplying electrical power to the backlight module 104 and other circuits of the display device 100. The control system 200 is coupled to the power supply 102 and the backlight module 104 for controlling the electrical power supplied to the backlight module 104. Preferably, the control system 200 is provided with image signals and other control signals inputted from an external graphic controller (not shown).

The gate driver 108 and the data driver 110 are connected to the control system 200 for driving the LCD panel 106 to display the image signals on the LCD panel 106.

In detail, the control system 200 includes a power management unit 210, a switch 220, a sensor 230, a signal processor 240, and a storage unit 250.

The power management unit 210 is coupled to the power supply 102 for powering on and powering off the backlight module 104.

The switch 220 is connected between the power management unit 210 and the sensor 230 for connecting or disconnecting the sensor to the power management unit 210. The switch 220 can be selected from a group consisting of a mechanical switch and an electronic switch. When the switch 220 is closed, power is able to flow though the switch 220 to the sensor 230. Thus the sensor 230 would be enabled to detect a state of the display device 100.

The sensor 230 can be an accelerometer for measuring an acceleration of the display device 100 so as to determine whether the display device 100 is shaken by a user. The sensor 230 generates an acceleration signal representing a magnitude of the acceleration of the display device 100.

The signal processor 240 is coupled to the power management unit 210, the sensor 230, and the storage unit 250 respectively. The signal processor 240 is configured for controlling the power management unit 210 to power on and power off the backlight module 104 based on the acceleration signal. If the acceleration signal is determined to be greater than a predetermined threshold, the signal processor 240 controls the power management unit 210 to change the state of the backlight module 104. That is, if the backlight module 104 is powered on, the power management unit 210 powers off the backlight module 104; if the backlight module 104 is powered off, the power management unit 210 powers on the backlight module 104. If the acceleration signal is determined to be less than the predetermined threshold, the signal processor 240 controls the power management unit 210 to keep the state of the backlight module 104.

The signal processor 240 includes a calculator 242, a controller 244, a detector 246, and an access unit 248. If the display device 100 is powered on, the controller 244 signals the detector 246 to detect the state of the backlight module 104. The detector generates a state value representing the state of the backlight module 104. For example, if the state value is “1,” the backlight module 104 is powered on, and if the state value is “0,” the backlight module 104 is powered off. The state value is sent to the access unit 249 for storing the state value in the storage unit 250.

If the sensor 230 is enabled and the display device 100 is shaken by the user, the sensor 230 measures the acceleration of the display device 100 and generates the acceleration signal representing the magnitude of the acceleration. The acceleration signal is transmitted to the calculator 242. The calculator 242 compares the acceleration signal with the predetermined threshold. If the acceleration signal is less than the predetermined threshold, the calculator 242 waits for receiving a next acceleration signal. If the acceleration signal is greater than the predetermined threshold, the calculator 242 signals the controller 244 to control the access unit 248 to read the state value stored in the storage unit 250.

After reading the state value, the access unit 248 transmits the state value to the calculator 242. The calculator 242 determines the state of the backlight module 104 based on the state value. If the state value is “1”, that is, if the backlight module 104 is powered on, the calculator 242 signals the controller 244 to power off the backlight module 104 by controlling the power management unit 210. The access unit 248 then changes the state value to “0” accordingly. If the state value is “0”, that is, if the backlight module 104 is powered off, the calculator 242 signals the controller 244 to power on the backlight module 104 by controlling the power management unit 210. The access unit 248 changes the state value to “1” accordingly.

The backlight module 104 of the display device 100 can be powered on or powered off by shaking the display device 100. If the display device 100 is shaken, the sensor 230 detects the acceleration and the signal processor 240 controls the power management unit 210 to change or keep the state of the backlight module 104 based on the acceleration. Therefore, when powering on or powering off the backlight module 104, it is not necessary to press a power switch of the display device 100.

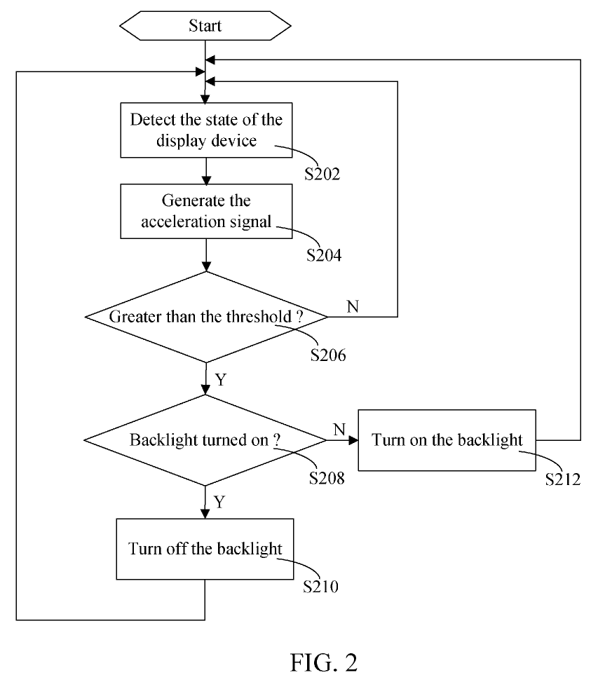

Referring to FIG. 2, a flow chart of a procedure to control the backlight module 104 of the display device 100 is illustrated. First, in step S202, the sensor 230 detects the state of the display device 100.

In step S204, the sensor 230 generates the acceleration signal representing the magnitude of the acceleration of the display device 100.

In step S206, the calculator 242 compares the acceleration signal with the predetermined threshold to determine whether the acceleration signal is greater than the predetermined threshold. If the acceleration signal is less than the predetermined threshold, the procedure goes back to step S202. If the acceleration signal is greater than the predetermined threshold, the procedure goes to step S208.

In step S208, the detector 246 detects the backlight module 104 to determine whether the backlight module 104 is powered on. If the backlight module 104 is powered on, the procedure goes to step S210 to power off the backlight module and goes back to step S202. If the backlight module 104 is not powered on, the procedure goes to step S212 to power on the backlight module 104 and goes back to step S202.

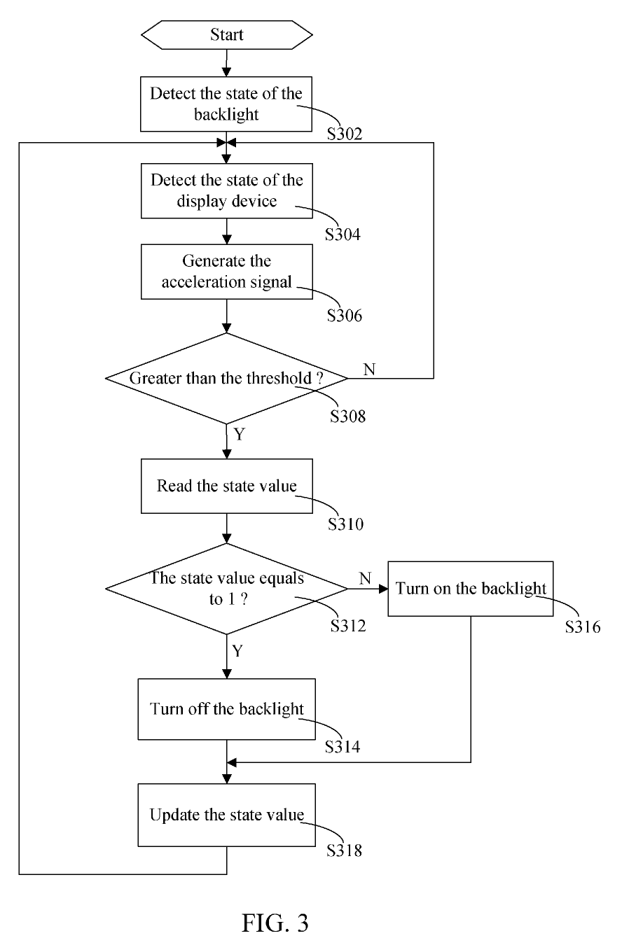

Referring to FIG. 3, a flow chart of an another procedure to control the backlight module 104 of the display device 100 is illustrated. In step S302, the detector 246 detects the state of the backlight module 104. The detector 246 generates a state value representing the state of the backlight module 104. For example, the state value is set to “1” representing the backlight module 104 is powered on, and the state value is set to “0” representing the backlight module 104 is powered off. The state value is sent to the access unit 249 for storing the state value in the storage unit 250.

In step S304, the sensor 230 measures the acceleration of the display device 100.

In step S306, the calculator 242 generates the acceleration signal representing the magnitude of the acceleration so as to detect whether the display device 100 is shaken by a user.

In step S308, the calculator 242 compares the acceleration signal with the predetermined threshold to determine whether the acceleration signal is greater than the predetermined threshold. If the acceleration signal is less than the predetermined threshold, the procedure goes back to step S304. However, if the acceleration signal is greater than the predetermined threshold, the procedure goes to step S310.

In step S310, the access unit 248 reads the state value stored in the storage unit 250 and transmits the state value to the calculator 242.

In step S312, the calculator 242 determines the state of the backlight module 104 based on the state value. If the state value is “1”, which indicates the backlight module 104 is powered on, the procedure proceeds to step S314.

In step S314, the calculator 242 signals the controller 244 to control the power management unit 210 to power off the backlight module 104.

After the backlight module 104 is powered off, the procedure proceeds to step S318 to update the state value stored in the storage unit 250, that is, the access unit 248 changes the state value to “0”.

If in step S312, it is determined that the state of the backlight module 104 is powered off, that is, the state value is “0”, the procedure proceeds to step S316. In step S316, the calculator 242 signals the controller 244 to control the power management unit 210 to power on the backlight module 104. After the backlight module 104 is powered on, the procedure proceeds to step S318 to update the state value stored in the storage unit, that is, the access unit 248 changes the state value to “1”.

As mentioned above, the present method of controlling the backlight module 104 of the display device 100 is able to power on or power off the backlight module 104 via detecting the acceleration of the display device 100. Thus, it is not necessary to power on or power off the backlight module 104 via pressing the power switch of the display device 100.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. A display device, comprising:
a backlight module;
a power management unit for powering on and powering off the backlight module;
a sensor for detecting an acceleration of the display device and generating an acceleration signal representing a magnitude of the acceleration; and
a signal processor configured for determining whether the acceleration signal is greater than a predetermined threshold and controlling the power management unit to change a state of the backlight module if the acceleration signal is greater than the predetermined threshold.

2. The display device as claimed in claim 1, wherein the signal processor controls the power management unit to maintain the state of the backlight module if the acceleration signal is less than the predetermined threshold.

3. The display device as claimed in claim 1, wherein the state of the backlight module comprises a powered on state and a powered off state.

4. The display device as claimed in claim 1, further comprising a switch connected between the power management unit and the sensor for connecting and disconnecting the sensor to the power management unit.

5. The display device as claimed in claim 1, further comprising a power supply for supplying electrical power to the backlight module.

6. The display device as claimed in claim 1, further comprising an LCD panel for displaying image signals, a gate driver and a data driver for driving the LCD panel.

7. The display device as claimed in claim 1, wherein the sensor is an accelerometer.

8. The display device as claimed in claim 1, wherein the signal processor comprises a calculator for comparing the acceleration signal with the predetermined threshold.

9. The display device as claimed in claim 1, wherein the signal processor comprises a controller for controlling the power management unit to power on and power off the backlight module.

10. The display device as claimed in claim 1, wherein the signal processor comprises a detector for detecting the state of the backlight module and generating a state value representing the state of the backlight module.

11. The display device as claimed in claim 10, further comprising a storage unit coupled to the signal processor.

12. The display device as claimed in claim 11, wherein the signal processor comprises an access unit for storing the state value to the storage unit.

13. A method for controlling a backlight module of a display device, comprising:
generating an acceleration signal representing the magnitude of an acceleration of the display device;
comparing the acceleration signal with a predetermined threshold to determine whether the acceleration signal is greater than the predetermined threshold; and
changing a state of the backlight module if the acceleration signal is greater than the predetermined threshold.

14. The method as claimed in claim 13, further comprising: maintaining the state of the backlight module if the acceleration signal is less than the predetermined threshold.

15. The method as claimed in claim 13, further comprising: detecting the state of the backlight module to determine whether the backlight module is powered on.

16. The method as claimed in claim 15, wherein the backlight module is powered off if it is detected the backlight module is powered on and the acceleration signal is greater than the predetermined threshold.

17. The method as claimed in claim 15, wherein the backlight module is powered on if it is detected the backlight module is not powered on and the acceleration signal is greater than the predetermined threshold.

18. A method for controlling a backlight module of a display device, comprising:
detecting a state of the backlight module to generate a state value representing the state of the backlight module;
storing the state value;
generating an acceleration signal representing the magnitude of an acceleration of the display device;
comparing the acceleration signal with a predetermined threshold to determine whether the acceleration signal is greater than the predetermined threshold;
reading the state value; and
changing the backlight module to a new state opposite to the state if the acceleration signal is greater than the predetermined threshold.

19. The method as claimed in claim 16, further comprising: updating the state value if the state of the backlight module is changed.

20. The method as claimed in claim 16, further comprising: maintaining the state of the backlight module if the acceleration signal is less than the predetermined threshold.
